(19) United States
(12) Patent Application Publication
(10) Pub. No.: US 2011/0277467 A1
(43) Pub. Date: Nov. 17, 2011

(54) Hybrid air turbine engine with heat recapture system for moving vehicle

(76) Inventor: Martin Dravis, Howard Beach, NY (US)

(21) Appl. No.: 12/800,280

(22) Filed: May 12, 2010

(51) Int. Cl. F02B 33/44; F04B 17/00

(52) U.S. Cl. 60/605.1; 417/405

(57) ABSTRACT

A non-fuel combusting air turbine assembly suitable as an auxiliary or primary power propulsion system for a vehicle. The system includes an air turbine engine powered by a compressor mechanism to increase the potential energy that can be harnessed by the turbines, having a noise reducing air intake section for delivering air to the compressor. Additionally, the system includes a turbine mechanism comprising plural sets of stationary vanes and rotating vanes, preferably arranged alternatively; and a battery rechargeable by a generator operable by the rotating turbine vanes.

### FIELD OF THE INVENTION

The present invention is directed to air turbine engine systems used to power a vehicle, augment the power of a vehicle, and/or drive a generator to produce electricity, more particularly to an engine system having a series of turbines that have different capabilities, such as acceleration, compression, and extraction of the force of the wind to power the vehicle. This engine works in conjunction with another power source, such as an internal combustion engine or a wind turbine.

### BACKGROUND OF THE INVENTION

The present invention relates to a unique air turbine engine system for a moving vehicle, such as an automobile, truck, airplane and the like.

This type of engine uses turbines to convert the energy produced by the compressors into mechanical energy in a similar manner to turbo prop and turbo shaft engines.

Concerns over the environment, specifically pollution of the atmosphere, record costs of conventional fuels, and inadequate refining capacity for gasoline, have renewed interest in alternate propulsion systems for moving vehicles. However, such interest has existed for a number of years, but have not yielded significant commercial systems to meet these concerns.

The prior art offers a number of turbine systems that may be used to power vehicles. Exemplary systems are noted in the following U.S. patents:

U.S. Pat. No. 6,408,641, to Skur, III, teaches a hybrid turbine coolant system where air is extracted from a pressurized air source. An air-to-air heat exchanger receives and cools the extracted pressurized air. Further, an expansion turbine receives at least a portion of the cooled pressurized air from the air-to-air heat exchanger and expands the cooled pressurized air into chilled air while extracting work. An air-to-coolant heat exchanger receives the chilled air from the expansion turbine which is used to chill refrigerant coolant. The air-to-air heat exchanger also receives the chilled air reclaimed from the air-to-coolant heat exchanger, subsequent to chilling the refrigerant coolant, to cool the air extracted from the pressurized air source.

U.S. Pat. No. 5,644,170, to Bynum et al., relates to an atmospheric/aqua turbine, an apparatus for producing energy by allowing air or water to be metered by controls through an adjustable air or water scoop into twin turbines to produce electricity when the atmospheric/aqua turbine is installed on vehicle or a boat. The turbine is effective for a vehicle traveling at 30 mph or more, and in the case of a boat traveling at 8 to 10 mph or more.

U.S. Pat. No. 4,314,160, to Boodman et al., is directed to a system to provide additional electrical power in an electrically powered vehicle. An air scoop is mounted on the vehicle. The air scoop opens in a generally forward direction. A turbine wheel is mounted in the rear of the air scoop. An electric generator is connected to the turbine wheel, whereby air passing through the air scoop will generate additional electricity for the vehicle batteries. The air scoop is rotatable and means are provided to lock it in position.

U.S. Pat. No. 3,904,883, to Horwinski, discloses a unit for supplying power with the least possible local pollution to the environment, where the unit comprises both a prime mover with the fuel supply and also significantly large storage means for electric energy. The unit involves basically a dynamo-electric machine with a commutator-type armature and salient-field type rotator surrounding and rotatably carrying the armature. The rotator is turnable and has sets of slip rings at its ends, for effecting electrical connections to the salient fields and also to brush holders which carry brushes bearing on the commutator. One opposite set of field pole windings is series connected and utilized as a series motor field winding, being connected with one set of brushes whereby the machine can operate as a series motor. Another set of field pole windings is adapted to function as a shunt generator field, the generator function involving a second set of brushes. All the said brushes bear on the same commutator. The armature shaft is coupled to drive a load which could for example be vehicle wheels or else a load of a stationary installation; and the rotary field structure or rotator is coupled to be driven by the prime mover which could be a gasoline engine, steam engine etc. Storage batteries are connected to drive the dynamo-electric machine as a series motor, such as for propelling a vehicle, and can be recharged by the shunt generator portion of the dynamo-electric machine when the armature of the latter is being driven by the prime mover or gasoline engine. Suitable automatic electronic controls can be provided to determine the various modes of functioning of the prime mover and dynamo-electric machine.

U.S. Pat. No. 3,556,239, to Spahn, covers a battery powered automobile which includes an air operated turbine fed by front and side air scoops for providing both charging current to the batteries and driving power for the automobile. An auxiliary internal combustion engine is included for use when necessary. Deceleration and wind sensitive controls operate door structure on the front air scoop so that it opens, increasing drag, only under predetermined conditions. Braking energy is utilized to help charge the batteries.

U.S. Pat. No. 3,444,946, to Waterbury, relates to an electric motor driven vehicle having at least one electric motor to supply power to said vehicle. The driving system further includes the a mechanism associated with each electric motor to supply electric power thereto comprising batteries arranged in series, and either a solar cell supplying energy to the batteries, a power-generating means with paddle wheel and venturi tube or both adapted to supply power to the batteries. The above combination may be used either alone or in conjunction with a conventional internal combustion engine.

These prior art systems, though offering supplemental propulsion mechanisms for moving vehicles, they fail to offer the efficiency needed to effect an alternative and supplemental mechanism for new vehicles and for retrofitting to existing vehicles in the manner of the present invention. The manner by which the present invention achieves the goals hereof will become more apparent from the following description and accompanying drawings.

### SUMMARY OF THE INVENTION

The present invention relates to a primary or an auxiliary power system for a vehicle selected from the class of automobiles, trucks, buses, ships, planes and the like. The invention teaches a turbo shaft variety of engine that uses turbines to convert energy produced by the airflow generated by compressors into mechanical energy.

In an embodiment of the invention, the system is used in conjunction with a secondary propulsion mechanism of a vehicle, namely an internal combustion engine. The system comprises a non-fuel burning, air turbine engine powered by a compressor mechanism to increase the potential energy that is harnessed by the turbines. The compressor is driven by the secondary power source, the internal combustion engine. The air turbine engine comprises an intake section, a centrifugal or axial operating compressor to actively accelerate and compress the air passing through a noise reducing intake member. The compressor mechanism is preferably powered by an internal combustion engine, but can be powered by numerous devices, including but not limited to; mechanical drive shaft to transmit power from the vehicles wheels, an internal combustion engine, or turbines placed in the intake. Power from a portion of the turbines aft of the compressor can assist all of these methods to further increase the velocity of the airflow.

Further, the air turbine system transmits the compressed air to a turbine assembly, where the assembly comprises plural concentric vanes. In a preferred arrangement, there is a first set of vanes stationary with a second set of vanes alternately positioned with the first set of vanes. That is, there is one stationary set of vanes between each set of moving compressor or turbine vane. Accordingly, the compressed air is directed to each turbine by a set of fixed nozzle guide vanes that speeds up the air and shoots it at the correct angle for the moving turbine blades. The stationary vanes also improve efficiency by reducing turbulence in the airflow. The stationary vanes are generally called stator vanes or turbine guide vanes in other applications.

Accordingly, a feature of the present invention lies in its use of one or more compressors to actively accelerate and compress incoming air for transmission to a turbine assembly.

Another feature hereof is an auxiliary power propulsion system that includes a compressor section and turbine assembly, where the energy from the turbine assembly is used to generate electricity, power a variety of vehicle components, power the vehicle, and augment the compressor drive. Using a portion of the turbines output to drive the compressor increases the efficiency of the system.

A further optional feature of the invention is an auxiliary power propulsion system for a vehicle where a driven axle of the vehicle may optionally drive the compressor section. In this configuration, the system generates electricity to offset some of the aerodynamic drag produced by vehicles such as trains.

Still another feature hereof is the provision of a turbine assembly that may optionally utilize plural, alternating sets of rotating turbine blades and guide blades.

A further feature of an embodiment of the present invention is a heat recapture system. This involves the use of an internal combustion engine to start the compressor. This embodiment includes a method of utilizing the radiated heat from the engine to increase the power of the turbine system. This is accomplished in two ways. One is the positioning of the internal combustion engine in the airflow generated by the air turbine system. Another method is routing the internal combustion engine's water cooling system into the airflow. These two methods can be used simultaneously to extract the maximum amount of the heat energy from the internal combustion engine and maximize efficiency.

This engine can incorporate my prior art, filing Ser. No. 11/699,843, and use a recirculation system and route the internal combustion engine's exhaust into the turbine section to maximize the efficiency of the system.

These and other features of this invention will become more apparent from the following description and accompanying drawings.

### BRIEF DESCRIPTION OF DRAWINGS

FIG. 1 is a simplified sectional and schematic view of a first embodiment for a power propulsion system for a vehicle according to the present invention.

FIG. 2 is a simplified sectional and schematic view of a second embodiment for a power propulsion system for a vehicle according to the present invention.

FIG. 3 is a simplified sectional and schematic view of a power propulsion system with intake turbines to drive the compressor.

FIG. 4 is a simplified sectional and schematic view of a power propulsion system where the output drives a vehicles axle.

### DETAILED DESCRIPTION OF THE PREFERRED EMBODIMENTS

A first embodiment of this invention relates to a non combusting air turbine to generate mechanical energy and includes primary or an auxiliary power propulsion system for a variety of vehicles to be used in conjunction with a secondary propulsion mechanism of the vehicle. Specifically, the preferred version hereof is designed for use on autos, trucks, trains, buses, ships, airplanes and other moving vehicles. The basic concept is an air turbine engine that is powered by a compressor or a series of compressors, which increase the potential energy that is harnessed by the turbines.

The system of the present invention is different from a standard turbo shaft engine or gas turbine engine in that it will not burn the compressed air. It is also different from other air turbines in that it employs a compressor(s) to actively accelerate and compress the air, where other versions of air turbines do not compress the air or they simply rely on the Bernoulli Effect to passively accelerate and compress the air. The compressors can be used either in conjunction with a funnel of decreasing size, taking advantage of the Bernoulli Effect or it can be used without a passive compression and acceleration device. In either case the use of compressors will greatly amplify the potential energy of any existing wind, or relative wind created by the motion of the vehicle.

This turbo shaft version of the air turbine engine is preferably used in conjunction with an internal combustion engine, an electric engine, or a mechanical drive powered by the movement of the wheels of a moving vehicle or another air turbine. Turbines placed in the intake of the engine itself can also power the compressor(s). In all versions, a portion of the power generated by the turbines down stream of the compressor can augment the compressor drive, increasing efficiency substantially.

A preferred embodiment uses a portion of the mechanical energy produced by the turbines to power a generator, which in turn produces electricity. The vehicle uses the electricity to power an electric motor to drive the vehicle. In the case of an aircraft, this air turbine system can be used to power an electrically driven jet engine. The system can incorporate batteries, wheel brake generators and other methods currently in use.

In a preferred embodiment, the present invention comprises an electrical generator for hybrid systems with increased efficiency. Using the air turbine system for an electrical generator has the advantage of being able to operate the air turbine at the optimum operating speed, increasing efficiency. Excess electricity can be stored in batteries. The air turbine system can be turned off when the batteries are full and restarted when the batteries discharge to a preset level. This maximizes fuel economy and extends the air turbine's useful life.

The mechanical energy produced by this air turbine system can be used to directly power the vehicle. In this instance, the air turbine system operates at variable speeds as required to operate the vehicle. A generator is only used to produce electricity for other uses, not for the primary drive system. This method has the advantage of incorporating a forward facing intake, to reduce aerodynamic drag and utilizing the relative wind produced by the motion of the vehicle. It has the further advantage of not requiring a large electrical generator, an electric motor or a large battery bank. It has the disadvantage that the air turbine is not operating at peak efficiency and there will be a reduced life span for the air turbine system.

A preferred method of powering the compressor fan is to utilize an internal combustion engine to initially power the compressor and direct a portion of the output from the air turbine engine's turbines to augment the internal combustion engine in powering the compressor. This increases velocity of the system's internal airflow and increases the efficiency of the air turbine system and the combined hybrid system.

Efficiency can also be increased by utilizing two sources of energy produced by the internal combustion engine that are normally wasted. One is the exhaust gases and the second is the radiated heat produced by the internal combustion engine.

My prior art, air turbine engine with recirculation system, Ser. No. 11/699,843 teaches using the exhaust gases to increase potential energy in the airflow and subsequently increasing the output of the turbines.

The pressure and velocity of the airflow can be further increased by utilizing the heat generated by the internal combustion engine. This is accomplished by placing the internal combustion engine, and all of its parts that radiate heat, such as the muffler and catalytic converter, in the airflow generated by the compressor or fan of the air turbine system. The heat radiated from the engine increases the temperature of the air turbines airflow. The increased temperature causes the air to expand, increasing the velocity of the airflow.

In applications using higher airflow velocities and pressures, this heat causes increased pressure, but that can be subsequently translated into increased velocities by expanding the volume of the airflow, as is done in turbo jet engines. Either way, using the radiated heat from the engine increases the output and efficiency of the air turbine system.

This method of using the radiated heat from the internal combustion engine may suffice to cool the internal combustion engine sufficiently, or in certain applications, a water radiator may be required to cool the engine. The radiator can be placed in the air turbine system's airflow or intake to accomplish the required cooling while still utilizing the radiated heat to increase the output and efficiency.

In this manner, the air turbine system uses more of the energy produced by the internal combustion engine, maximizing efficiency.

An internal combustion engine has the advantage of on demand power and that it is not limited to electric lines. Where electric lines are readily available, such as electric train systems, this air turbine system can be used in conjunction with the current electric drive. Then the air turbine system will reduce the amount of electricity used by the train, increasing efficiency.

When used in conjunction with an electrically powered train or other vehicle, the air turbine system can use a mechanical drive to start the rotation of the compressor. Then the air turbine will use the relative wind produced by the motion of the vehicle to produce electricity and increase the efficiency of the vehicle. Again by directing a portion of the turbine output to increase the rotation of the compressor fan, the air turbine system can increase its efficiency. Using a portion of the turbines output to augment the primary compressor drive can also reduce the aerodynamic drag on the vehicle, if the compressor fan increases the intake air velocity above the velocity of the vehicle, and hence the vehicle's relative wind, which is equal to the velocity of the vehicle.

In an embodiment, intake turbines are used to start the compressor.

Turbines can also be placed in the intake to start the compressor. This variant requires a forward facing intake. It also requires an additional motor to start the motion of the vehicle. Therefore, this embodiment is best suited as a secondary engine to reduce the amount of power required from the primary drive, thereby increasing efficiency.

This embodiment comprises at least one intake turbine, a compressor fan and multiple turbines aft of the compressor. The intake turbine or turbines starts the rotation of the compressor fan. The compressor fan rotation increases the velocity of the airflow above the velocity of the relative wind generated by the motion of the vehicle. The air is then directed to the turbines downstream of the compressor fan generating mechanical energy. As in the other embodiments, a portion of the downstream turbines' power can be directed to drive the compressor. This increases the rotational speed and airflow produced by the compressor over what it would produce if it is driven solely by the intake turbines.

There are two ways to use the power produced by this engine. One is to convert the mechanical energy to electricity and use the electricity to augment the vehicle's primary drive. The second method is to use a direct drive for the mechanical energy produced by the air turbine. There are multiple methods of accomplishing this.

One method is to employ a direct drive system to channel the mechanical energy to one of the vehicle's axles. This method reduces the power required from the primary drive to maintain the vehicle's motion at high speeds. It is particularly effective when used in conjunction with an electric motor, as electric motors are very effective at low speeds. An example would be the Toyota Prius, which can use the electric motor as the sole drive up to 30 mph, then it must be augmented by a gasoline engine. An air turbine with intake turbines could replace the gasoline motor in a Prius, making it an electric/air turbine hybrid. The battery could be charged by a plug in charger or by a small generator. This could also be used in the Chevrolet Volt, extending the range from its battery.

For an electrically powered vehicle, such as an electric train, the air turbine's mechanical energy could be converted to electricity by a generator. The electricity could then reduce the amount of power required from the grid, or any other source the vehicle might use.

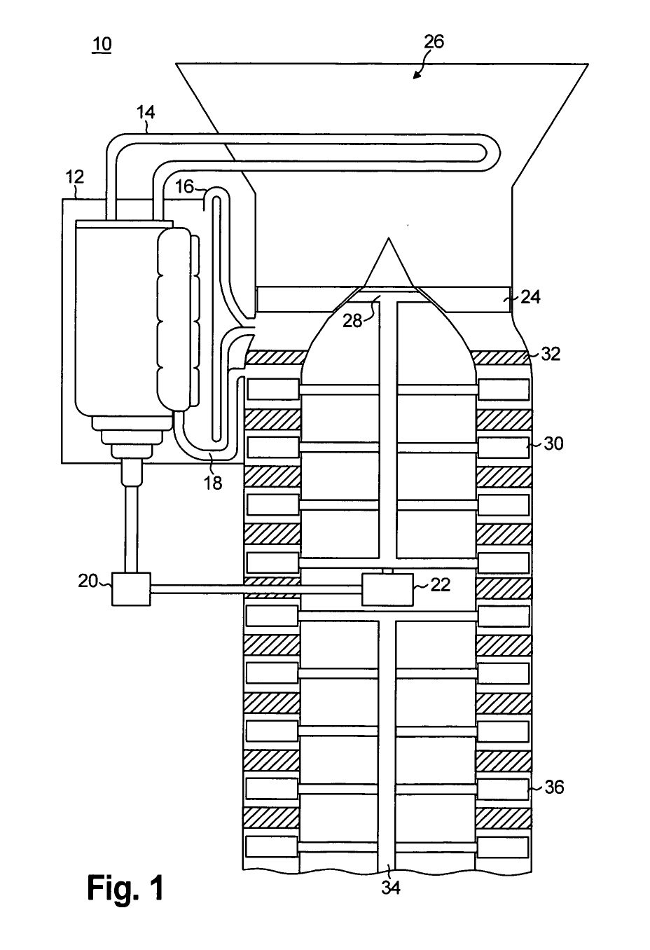

FIG. 1 relates to a power propulsion system 10 having an internal combustion engine 12. The internal combustion engine 12 has a radiator 14 which transfers heat from the cooling water to the turbine airflow. The internal combustion engine 12 further comprises a heat transfer airflow duct 16 and an exhaust pipe 18 which is connected to the turbine section. The internal combustion engine 12 is connected to connecting gear 20 which is an angled shaft from the internal combustion engine 12 to the main transmission 22. The transmission 22 receives power from the internal combustion engine 12 and may also receive power from the turbines which helps drive the compressor 24. The power propulsion system 10 further comprises an intake 26 and a compressor drive shaft 28. The device further comprises turbines 30 which help to drive the compressor 24. The device further includes stator vanes 32 and a turbine drive shaft 34. Turbines 36 transmit power to drive the vehicle.

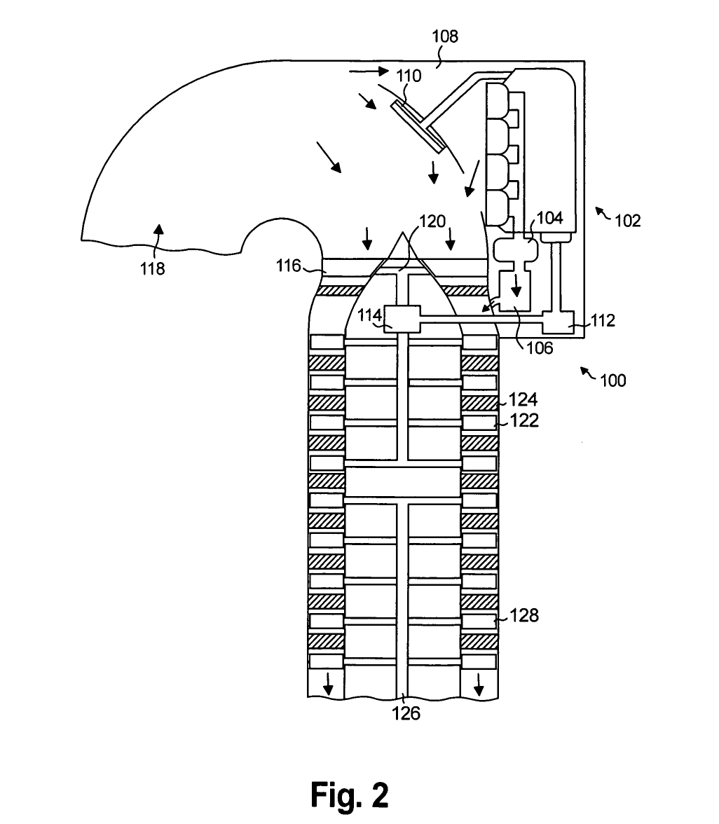

FIG. 2 shows a sectional and schematic view of a second embodiment for a power propulsion system for a vehicle. The device 100 has an internal combustion engine 102 a catalytic converter 104 and a muffler 106. The device further comprises an air space 108 to transfer heat from the combustion engine 102 to the turbine intake. The radiator 110 transfers heat from the cooling water to the turbine airflow. The internal combustion engine 102 is connected to connecting gear 112 which is an angled shaft from the internal combustion engine 102 to the main transmission 114. The transmission 114 receives power from the turbines and the internal combustion engine 102 which helps drive the compressor 116. The power propulsion system 100 further comprises an intake 118 and a compressor drive shaft 120. The device further comprises turbines 122. The device includes stator vanes 124 and a turbine drive shaft 126. Turbines 128 transmit power to drive the vehicle.

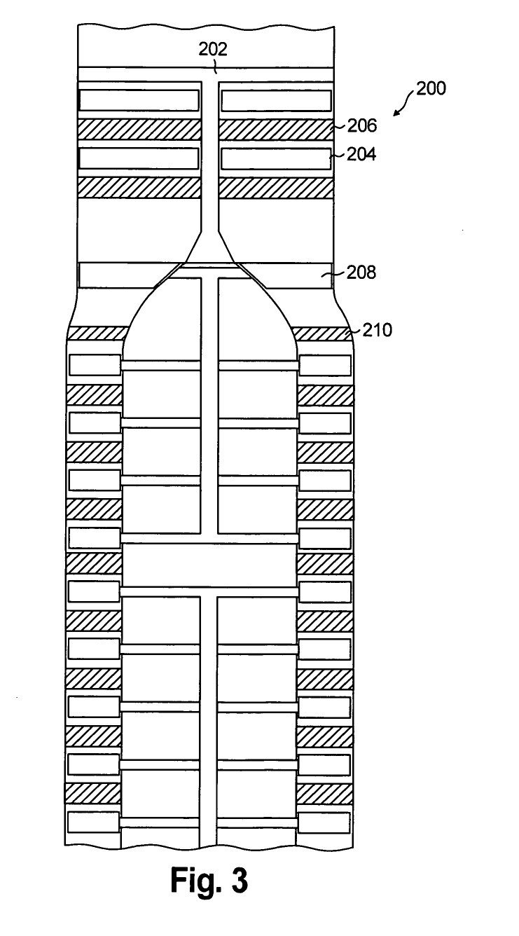

FIG. 3 relates to a power propulsion system 200. The device comprises a intake turbines 202 and 204 to drive the compressor 208, and stator vanes 206. The device further comprises a compressor 208 and further stator vanes 210. The energy produced by the turbines and stator vanes is the same as what is shown in FIG. 1 and FIG. 2.

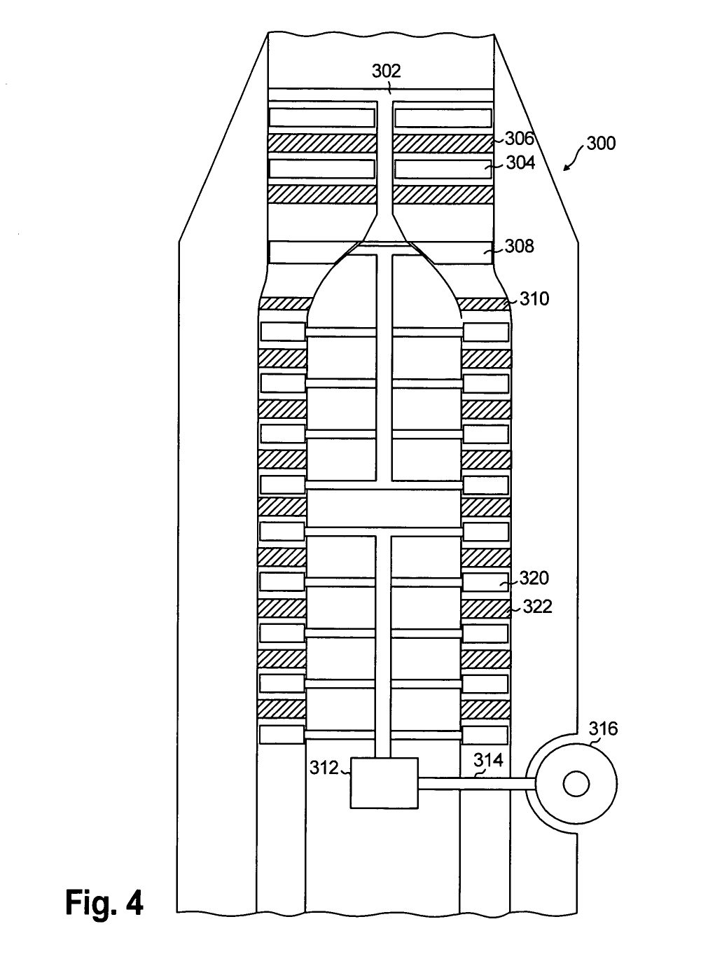

FIG. 4 relates to a power propulsion system 300. The system has turbines 302 and 304 to drive the compressor 308, and stator vanes 306. The system further comprises a compressor 308 and further stator vanes 310. The system has a transmission 312, a drive shaft 314 and a axle 316. The transmission 312 powers the axle 316 through the drive shaft 314. The energy produced by the turbines 320 and stator vanes 322 is used to drive the axle 316.

It is recognized that changes, variations and modifications may be made to the various embodiments for the air turbine system of this invention without departing from the spirit and scope thereof. Accordingly, no limitation is intended to be imposed thereon except as set forth in the accompanying claims.

I claim:

1. A power propulsion system for a vehicle, where said system is used in conjunction with a secondary power source, said system comprising:
a non fuel combusting air turbine engine powered by a compressor mechanism to increase potential energy harnessed by turbines;
said non fuel combusting air turbine engine comprising an air intake member, an operating compressor to actively accelerate and compress air passing through said intake member;
an enclosed airflow passage to transmit said accelerated air to a turbine assembly, where said assembly comprises plural concentric vanes, a first set of said vanes being stationary and a second set of rotating vanes alternately positioned with said first set of vanes, and
an air exhaust in communication with said first and second sets of vanes;
said system including a drive shaft connected to said second set of said vanes to produce mechanical energy.

2. The power propulsion system according to claim 1, wherein a portion of the power generated by said second set of rotating vanes is directed to augment said compressor.

3. The power propulsion system according to claim 1, wherein the compressor is driven by turbines placed in the air turbine's intake.

4. The power propulsion system according to claim 1, further comprising a generator operated by said drive shaft to generate electricity.

5. The power propulsion system according to claim 1, incorporating an internal combustion engine to start the compressor, wherein the exhaust from the internal combustion engine is vented into the air turbine's air stream, increasing the energy in said air stream that can be extracted by the rotating vanes.

6. The power propulsion system according to claim 1, wherein mechanical energy from an internal combustion engine powers said compressor.

7. The power propulsion system according to claim 1, further comprising incorporating an internal combustion engine to start the compressor, where the internal combustion engine, and its heat generating parts; including its radiator, muffler and catalytic converter are positioned in the air turbine system's airflow to heat the airflow and increase the energy that is extracted by the rotating vanes.

8. The power propulsion system according to claim 1, further comprising incorporating an internal combustion engine to start the compressor, where said internal combustion engine and its heat generating parts are positioned in the air turbine's intake to heat the air turbine's airflow, increasing the energy that is extracted by the rotating vanes and to reduce intake icing.

9. A power propulsion system according to claim 3, wherein the output from a portion of the turbines is mechanically directed to one of the vehicle's axles to assist in propelling the vehicle.
